(19) United States
(12) Patent Application Publication
(10) Pub. No.: US 2025/0253322 A1
(43) Pub. Date: Aug. 7, 2025

(54) COMPOSITION FOR LITHIUM METAL PROTECTIVE LAYER, LITHIUM ELECTRODE AND METHOD OF FABRICATING LITHIUM ELECTRODE

(71) Applicant: SK ON CO., LTD., Seoul (KR)

(72) Inventors: Seong Jin PARK, Daejeon (KR); Yun Sun CHO, Daejeon (KR); Dong Won KIM, Seoul (KR); Hyo Jin KIM, Seoul (KR); Ye Eun PARK, Seoul (KR); Hui Tae SIM, Seoul (KR); Myung Keun OH, Seoul (KR)

(21) Appl. No.: 19/024,938

(22) Filed: Jan. 16, 2025

(30) Foreign Application Priority Data
Feb. 6, 2024 (KR) 10-2024-0018217

(51) Int. Cl. H01M 4/36; H01M 4/02; H01M 4/04; H01M 4/1395; H01M 4/40; H01M 4/62

(52) U.S. Cl. CPC H01M 4/366; H01M 4/0402; H01M 4/1395; H01M 4/405; H01M 4/628; H01M 2004/021; H01M 2004/027

(57) ABSTRACT

A composition for a lithium metal protective layer includes an organic solvent comprising nitromethane and dimethoxyethane, and lithium nitrate (LiNO₃). A content of nitromethane is in a range from 30 wt % to 70 wt % based on a total weight of the organic solvent. In a method of fabricating a lithium electrode, a protective layer is formed on a surface of a lithium metal layer by immersing the lithium metal layer in the composition for a lithium metal protective layer.

### CROSS-REFERENCE TO RELATED APPLICATION AND CLAIM OF PRIORITY

This application claims priority to Korean Patent Application No. 10-2024-0018217 filed on Feb. 6, 2024 in the Korean Intellectual Property Office (KIPO), the entire disclosure of which is incorporated by reference herein.

### TECHNICAL FIELD

The disclosure of this patent application relates to a composition for a lithium metal protective layer, a lithium electrode and a method of fabricating a lithium electrode.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile, a hybrid vehicle.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

Graphite and silicon are mainly used as an anode material for the lithium secondary battery. Graphite and silicon have high reaction potentials and may not provide sufficient energy density and capacity for the lithium secondary battery. A lithium metal has low potential and high capacity, and thus may provide high efficiency and energy density for the lithium secondary battery.

However, the lithium metal has a high reactivity and may react with an electrolyte during charge and discharge processes, and an unstable film may be formed on a surface of the lithium metal. A current distribution on the surface of the lithium metal may become non-uniform due to the film, and ion conductivity and mechanical strength may be degraded. Further, an irregular growth of lithium may occur on the surface of the lithium metal during the charge process to form lithium dendrites. Accordingly, short circuit, heat generation, and explosion of an electrode may be caused.

### SUMMARY

According to an aspect of the present disclosure, there is provided a composition for a lithium metal protective layer.

According to an aspect of the present disclosure, there is provided a lithium electrode having improved stability.

According to an aspect of the present disclosure, there is provided a method of fabricating the lithium electrode.

According to an aspect of the present disclosure, there is provided a lithium secondary battery having improved stability.

A composition for a lithium metal protective layer includes an organic solvent including nitromethane and dimethoxyethane, and lithium nitrate (LiNO₃). A content of nitromethane is in a range from 30 wt % to 70 wt % based on a total weight of the organic solvent.

In some embodiments, the content of nitromethane may be in a range from 40 wt % to 70 wt % based on the total weight of the organic solvent.

In some embodiments, a content of dimethoxyethane is in a range from 30 wt % to 70 wt % based on the total weight of the organic solvent.

In some embodiments, a weight ratio of nitromethane to dimethoxyethane in the organic solvent is in a range from 0.5 to 2.0.

In some embodiments, a content of lithium nitrate may be in a range from 0.01 wt % to 3.0 wt % based on a total weight of the composition.

In some embodiments, the organic solvent may further include at least one auxiliary solvent selected from the group consisting of methylpyrrolidone, dimethylformamide, dimethylacetamide, acetonitrile, dinitrobenzene, dimethyl sulfoxide, dimethyl ether, dimethyl carbonate and tetrahydrofuran.

In some embodiments, the composition may further include at least one lithium salt selected from the group consisting of lithium bistrifluoromethanesulfonylimide (LiTFSI), lithium bisfluorosulfonylimide (LiFSI), lithium difluorooxalatoborate (LiDFOB), lithium bisoxalatoborate (LiBOB), lithium hexafluorophosphate (LiPF₆), lithium tetrafluoroborate (LiBF₄) and lithium perchlorate (LiClO₄).

In some embodiments, a protective layer is formed on a surface of a lithium metal layer by immersing the lithium metal layer in the above-described composition for a lithium metal protective layer.

In some embodiments, a lithium metal and the composition for a lithium metal protective layer may react on a surface of the lithium metal layer to form lithium nitride and lithium oxide.

In some embodiments, lithium nitride and lithium oxide may be formed by a reductive reaction of nitromethane and lithium nitrate.

In some embodiments, the lithium metal layer on which the protective layer is formed may be washed with dimethoxyethane.

A lithium electrode includes a lithium metal layer, and a protective layer disposed on the lithium metal layer and including lithium nitride and lithium oxide. In an O 1s spectrum of the protective layer measured by an X-ray photoelectron spectroscopy (XPS), a ratio of an area of a peak corresponding to Li₂O to an area of a peak corresponding to Li₂CO₃ is in a range from 1.0 to 1.9.

In some embodiments, in the O 1s spectrum of the protective layer, the ratio of the area of the peak corresponding to Li₂O to the area of the peak corresponding to Li₂CO₃ may be in a range from 1.2 to 1.9.

In some embodiments, in the O 1s spectrum of the protective layer, a ratio of the area of the peak corresponding to Li₂O to an area of a peak corresponding to a N—O bond may be in a range from 5 to 15.

In some embodiments, a thickness of the protective layer may be in a range from 10 nm to 2 μm.

A lithium secondary battery includes the above-described lithium electrode, a cathode facing the lithium electrode, and a solid electrolyte disposed between the lithium electrode and the cathode.

A composition for a lithium metal protective layer may include a mixed solvent of nitromethane and dimethoxyethane, and lithium nitrate. A content of nitromethane may be adjusted to a specific range. The composition for a lithium metal protective layer may react with a lithium metal to form a stable and uniform protective layer on a surface of the lithium metal. A growth of lithium dendrites may be suppressed, and ionic conductivity and mechanical strength of a lithium electrode may be improved.

The lithium electrode includes a lithium metal layer and a protective layer. The protective layer may include lithium nitride and lithium oxide, and a Li₂CO₃ peak and a Li₂O peak in an XPS spectrum of the protective layer may have a specific area ratio. Thus, ionic conductivity, stability and mechanical properties of the protective layer may be improved. Accordingly, life-span and capacity properties of a lithium secondary battery may be improved.

The lithium secondary battery according to the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 is a schematic cross-sectional view illustrating a lithium secondary battery in accordance with example embodiments.

FIG. 2 is a graph showing C 1s spectra of Example 1, Comparative Example 3, and Comparative Example 6.

FIG. 3 is a graph showing N 1s spectra of Example 1, Comparative Example 3, and Comparative Example 6.

FIG. 4 is a graph showing O 1s spectra of Example 1, Comparative Example 3, and Comparative Example 6.

FIG. 5 is a surface scanning electron microscope (SEM) image of a lithium electrode according to Comparative Example 6.

FIG. 6 is a surface SEM image of a lithium electrode according to Comparative Example 3.

FIG. 7 is a surface SEM image of a lithium electrode according to Example 1.

FIG. 8 is a charge/discharge curve graph of a lithium secondary battery according to Example 1.

FIG. 9 is a charge/discharge curve graph of a lithium secondary battery according to Comparative Example 6.

FIG. 10 is a charge/discharge curve graph of a lithium secondary battery according to Comparative Example 3.

FIG. 11 is a charge/discharge curve graph of a lithium secondary battery according to Comparative Example 2.

FIG. 12 is a scanning electron microscope-energy dispersive X-ray spectroscopy (SEM-EDX) image of an interface between a lithium electrode and a solid electrolyte of Example 1.

FIG. 13 is a SEM-EDX image of an interface between a lithium electrode and a solid electrolyte of Comparative Example 6.

### DETAILED DESCRIPTION OF THE EMBODIMENTS

According to embodiments of the present disclosure, a composition for a lithium metal protective layer is provided.

According to embodiments of the present disclosure, a method of fabricating a lithium electrode using the composition for a lithium metal protective layer and a lithium electrode are provided.

The terms “top”, “bottom”, “upper”, “lower”, “upper”, “lower”, “lower”, “lower”, “first”, “second”, etc., are used in a relative sense to distinguish different elements or positions, and do not specify an absolute position or an absolute order.

The terms “on”, “over”, “on”, or “between” as used herein refers to a direct placement/connection/combination, and also refers to a case where another element is interposed two different elements.

Hereinafter, the present disclosure will be described in detail with reference to the attached drawings and example embodiments. However, those are merely provided as examples and the present disclosure is not limited to the specific embodiments disclosed herein.

A composition for a lithium metal protective layer according to the embodiments of the present disclosure (hereinafter, that may be abbreviated as a protective layer composition) includes an inorganic nitrate and an organic solvent.

The protective layer composition may react with a lithium metal, and a protective layer may be formed on a surface of the lithium metal. For example, a lithium electrode including a lithium metal layer and the protective layer may be obtained using the protective layer composition.

The protective layer may include organic and inorganic materials derived from the reaction of the protective layer composition and the lithium metal. A reaction between the lithium metal and an electrolyte may be suppressed by the protective layer, decomposition of the electrolyte may be suppressed, and an interfacial resistance of the lithium metal may be reduced.

The inorganic nitrate includes lithium nitrate. Lithium nitrate (LiNO₃) has nitrogen and oxygen atoms, so that lithium nitrate and the lithium metal may react to form lithium nitride and lithium oxide on the surface of the lithium metal.

An ion conductivity on the surface of the lithium metal may be improved and the interfacial resistance may be reduced by lithium nitride. Thus, a current distribution on the surface of the lithium metal may become uniform, and mobility of lithium ions may be facilitated, so that growth of lithium dendrites may be suppressed.

A mechanical strength of the surface of the lithium metal may be increased by lithium oxide. Accordingly, shape deformation and short circuit due to the growth of lithium dendrites may be prevented, and stability of the lithium metal may be further improved.

Additionally, e.g., in a solid battery, a strong pressure may be applied for bonding an electrode and a solid electrolyte layer. The protective layer may have a high strength by lithium oxide, so that damages and deformation of the protective layer due to the strong pressure may be suppressed. Thus, a contact and a side reaction between the lithium metal and the electrolyte may be suppressed by the stable protective layer.

The organic solvent includes nitromethane and dimethoxyethane. For example, the organic solvent may be a mixed solvent of nitromethane and dimethoxyethane.

Nitromethane (CH₃NO₂) may have nitrogen and oxygen atoms, and may react with the lithium metal to be converted into lithium nitride and lithium oxide. Accordingly, the protective layer including lithium nitride and lithium oxide may be formed on the surface of the lithium metal, and the ionic conductivity, mechanical properties and electrochemical stability may be improved.

Nitromethane and dimethoxyethane have carbon atoms, and an organic material such as ROCO₂Li, ROLi (R is a hydrocarbon group such as an alkyl group), a polymer including (—CH₂—CH₂—O)n, etc., may be formed on the surface of the lithium metal due to a decomposition reaction of nitromethane and dimethoxyethane. The protective layer may become denser due to the organic material derived from nitromethane, and a contact between inorganic materials in the protective layer may be improved.

For example, the inorganic materials may exist in the form of particles in the protective layer, and thus the growth of the lithium dendrites may be promoted by voids between inorganic particles. An operating voltage may be lowered and an energy density may be lowered due to the lithium dendrite.

In example embodiments, the voids between the inorganic particles may be reduced and the contact between the inorganic materials may be improved by the organic material. Thus, the growth of the lithium dendrites may be suppressed and the energy density may be increased, thereby improving the capacity properties.

Additionally, during charging and discharging process, a volume of lithium metal may be changed due to deposition and desorption of the lithium metal. The organic material may buffer a pressure caused by the volume change, so that an interface between the inorganic material and the lithium metal may be stabilized.

Dimethoxyethane may have a high affinity and compatibility with nitromethane and lithium nitrate. Accordingly, dimethoxyethane may be mixed with nitromethane to form a uniform mixed solvent, and lithium nitrate may be dissociated in the mixed solvent by dimethoxyethane.

Thus, a viscosity of the protective layer composition may be reduced by dimethoxyethane, and a degree of dissociation of lithium nitrate may be increased so that the stable protective layer may be formed on the surface of the lithium metal. For example, nitromethane and nitrate ions may be uniformly distributed in the protective layer composition so that the uniform protective layer may be formed on the entire surface of the lithium metal.

A content of nitromethane based on a total weight of the organic solvent may be 30 weight percent (wt %) or more. In the above range, contents of lithium oxide and lithium nitride in the protective layer may be increased, so that the interfacial resistance of the lithium metal may be lowered. Further, the formation of the organic material in the protective layer may be promoted by the decomposition of nitromethane, so that the mechanical strength may be increased, and the life-span and capacity properties of the lithium secondary battery may be improved.

For example, when the content of nitromethane is less than 30 wt % based on the total weight of the organic solvent, the content of the organic material in the lithium protective layer may be small, and the growth of the lithium dendrites may be promoted and the energy density may be lowered. Lithium oxide and lithium nitride may not be sufficiently formed to degrade the ion conductivity and mechanical strength of the protective layer.

Further, when the content of nitromethane is less than 30 wt %, the content of dimethoxyethane may be relatively increased compared to that of nitromethane, and impurities derived from dimethoxyethane may be increased. For example, dimethoxyethane does not have a nitrogen atom, and a ratio of lithium nitride in the protective layer may be decreased to degrade the ion conductivity of the protective layer. Furthermore, lithium carbonate (Li₂CO₃) may be formed by the decomposition reaction of dimethoxyethane, and the interfacial resistance of the lithium metal and the side reaction with the electrolyte may be increased. Accordingly, the life-span and capacity properties may be deteriorated.

In example embodiments, the content of nitromethane may be in a range from 30 wt % to 70 wt % based on the total weight of the organic solvent. When the content of nitromethane is 70 wt % or less, the degree of dissociation of lithium nitrate in the organic solvent may be increased, and a reaction rate between the protective layer composition and the lithium metal may be controlled, so that the uniform and stable protective layer may be formed.

In some embodiments, the content of nitromethane may be in a range from 40 wt % to 70 wt %, from 40 wt % to 60 wt %, or from 50 wt % to 60 wt % based on the total weight of the organic solvent. When the content of nitromethane is in the above range, the more uniform and stable protective layer may be formed on the surface of the lithium metal by the protective layer composition. Additionally, the mechanical properties and the ion conductivity of the protective layer may be further improved, and the life-span of the lithium secondary battery may be enhanced.

In example embodiments, the content of dimethoxyethane may be in a range from 30 wt % to 70 wt % based on the total weight of the organic solvent. In the above range, the more uniform and stable protective layer may be formed on the surface of the lithium metal. Thus, the interfacial resistance of the lithium electrode may be reduced, and mechanical and chemical stability may be further improved.

For example, dimethoxyethane may have a low reactivity with respect to lithium metal, and thus a reactivity between the protective layer composition and the lithium metal may be controlled by dimethoxyethane. For example, as the contents of nitromethane and lithium nitrate increase, the reaction rate between the lithium metal and the protective layer composition may be increased. In this case, the protective layer may be formed unevenly on the surface of the lithium metal due to a rapid reaction rate.

For example, when the content of dimethoxyethane is 70 wt % or less, a generation amount of lithium oxide or lithium nitride may be increased relatively to a generation amount of lithium carbonate. Accordingly, the ionic conductivity of the protective layer may be increased, and electrochemical stability and mechanical strength may be further improved.

In some embodiments, the content of dimethoxyethane may be in a range from 30 wt % to 60 wt %, from 30 wt % to 50 wt %, or from 40 wt % to 50 wt % based on the total weight of the organic solvent.

In some embodiments, a weight ratio of nitromethane to dimethoxyethane in the organic solvent may be in a range from 0.5 to 2.0. In the above range, the reactivity between the protective layer composition and the lithium metal may be appropriately controlled, and the more stable and uniform protective layer may be formed. Additionally, the content of the organic material in the protective layer may be increased, and the ratio of lithium oxide and lithium nitride in the inorganic materials may be increased.

In some embodiments, the weight ratio of nitromethane to dimethoxyethane in the organic solvent may be in a range from 0.8 to 2.0, from 0.9 to 1.5, or from 1.0 to 1.2. In the above range, the reactivity of the protective layer composition and the degree of dissociation of lithium nitrate may be appropriately controlled so that the protective layer may be formed more uniformly. Additionally, components of the protective layer (e.g., the content of the organic material and the inorganic material) may be easily adjusted to a desired range, so that the life-span properties may be improved and the resistance may be reduced.

In some embodiments, a content of the organic solvent may be 90 wt % or more, 97 wt % or more, 99 wt % or more, and 99.99 wt % or less, 99.98 wt % or less, or 99.95 wt % or less based on the total weight of the protective film composition. In the above range, the reaction rate of the lithium metal and the protective layer composition may be controlled to form the uniform protective layer, and ratios of the organic material, or lithium nitride and lithium oxide in the protective layer may be controlled to a desired range.

In example embodiments, a content of lithium nitrate may be in a range from 0.01 wt % to 3.0 wt % based on the total weight of the protective layer composition.

For example, when the content of lithium nitrate is less than 0.01 wt %, a reaction between the organic solvent and the lithium metal may be relatively increased, thereby increasing a content of lithium carbonate in the protective layer. Further, lithium carbide (Li—C) may be formed by a reaction between lithium carbonate and the lithium metal, and a ratio of inorganic impurities to lithium oxide and lithium nitride may be increased. In this case, the life-span and capacity properties of the lithium secondary battery may be deteriorated.

When the content of the lithium nitrate is 3.0 wt % or less, the viscosity of the protective layer composition may be lowered, and a reductive reaction may easily occur on the surface of the lithium metal. Thus, the more stable protective film may be formed. Additionally, the thin protective layer may be uniformly formed, so that the interfacial resistance may be reduced and the ion conductivity may be further increased.

In some embodiments, the content of the lithium nitrate may be in a range from 0.05 wt % to 3.0 wt %, from 0.05 wt % to 2.0 wt %, or from 0.05 wt % to 1.0 wt % based on the total weight of the protective layer composition. In the above range, interfacial properties of the protective layer may be further improved while generation of impurities may be suppressed and generation of lithium nitride and lithium oxide may be further promoted.

In some embodiments, the organic solvent may further include an auxiliary solvent in addition to dimethoxyethane and nitromethane. For example, the degree of dissociation of lithium nitrate, the reactivity between the composition and lithium metal, and the viscosity of the protective layer composition may be controlled by the auxiliary solvent.

In an embodiment, the auxiliary solvent may include at least one of methylpyrrolidone, dimethylformamide, dimethylacetamide, acetonitrile, dinitrobenzene, dimethylsulfoxide, dimethylether, dimethylcarbonate and tetrahydrofuran. These may be used alone or in a combination of two or more therefrom.

In an embodiment, a content of the auxiliary solvent may be 20 wt % or less, 15 wt % or less, or 10 wt % or less based on the total weight of the organic solvent. In the above range, the ratio of lithium oxide and lithium nitride in the protective layer may be appropriately controlled, and the stable and uniform protective film may be formed.

In an embodiment, the content of the auxiliary solvent may be more than 0 wt %, 0.5 wt % or more, 1 wt % or more, or 3 wt % or more based on the total weight of the organic solvent.

In some embodiments, the protective layer composition may further include a lithium salt. The lithium salt may facilitate mobility of lithium ions in the protective layer composition and promote the reactivity with the lithium metal.

For example, the lithium salt may include at least one of lithium bistrifluoromethanesulfonylimide (LiTFSI), lithium bisfluorosulfonylimide (LiFSI), lithium difluorooxalatoborate (LiDFOB), lithium bisoxalatoborate (LiBOB), lithium hexafluorophosphate (LiPF₆), lithium tetrafluoroborate (LiBF₄) and lithium perchlorate (LiClO₄). These may be used alone or in a combination of two or more therefrom.

In an embodiment, a concentration of the lithium salt may be in a range from 0.1 M to 5.0 M, from 0.5 M to 2.0 M, or from 0.5 M to 1.0 M. In this range, an increase in viscosity due to the lithium salt may be suppressed, and a degree of dissociation of lithium ions may be increased, thereby improving the reactivity between the protective layer composition and the lithium metal.

According to embodiments of the present disclosure, a lithium electrode may be fabricated using the protective layer composition according to the above-described embodiments.

A lithium metal layer may be immersed in the protective layer composition. A protective layer may be formed on a surface of the lithium metal layer by the protective layer composition. For example, a lithium metal and the protective layer composition may react with each other on the surface of the lithium metal layer to form the protective layer.

For example, nitromethane and lithium nitrate of the protective layer composition can react with lithium to form lithium oxide and lithium nitride on the surface of the lithium metal layer. An organic material may be formed by a decomposition reaction of nitromethane, so that lithium oxide and lithium nitride may be firmly bound, and the protective layer including organic and inorganic materials may be formed on the surface of the lithium metal layer.

Dimethoxyethane may have a reactivity with the lithium metal less than that of nitromethane and lithium nitrate. Thus, nitromethane and lithium nitrate may react with the lithium metal in advance, and an amount of inorganic impurities such as lithium carbonate that may be generated by a reaction of dimethoxyethane and the lithium metal may be reduced.

In an embodiment, a reaction temperature of the lithium metal layer and the protective layer composition may be in a range from 40° C. to 80° C., or from 50° C. to 70° C. In the above range, the reactivity and the reaction rate may be appropriately controlled to form the thin and uniform protective layer.

In an embodiment, a reaction time of the lithium metal layer and the protective layer composition may be in a range from 0.5 hours to 4 hours, or from 0.5 hours to 2 hours. In the above range, the stable protective layer may be formed while suppressing generation of by-products due to an over-reaction.

In some embodiments, the lithium metal layer on which the protective layer is formed, e.g., a preliminary lithium electrode may be taken out from the protective layer composition. The preliminary lithium electrode may be washed with dimethoxyethane.

The preliminary lithium electrode may be washed with a base solvent of the protective layer composition, so that nitromethane and lithium nitrate remaining on the surface of the lithium metal layer may be removed. Additionally, components of the protective layer may have a low solubility in dimethoxyethane, so that the protective layer may remain on the lithium electrode. Accordingly, the stable protective layer may be formed while suppressing side reactions due to nitromethane and lithium nitrate during charge/discharge processes.

In some embodiments, the preliminary lithium electrode may be dried to obtain a lithium electrode. The organic solvent remaining in the preliminary lithium electrode may be removed by the drying process. In an embodiment, the drying process may be performed at room temperature.

Hereinafter, a lithium electrode and a lithium secondary battery according to embodiments of the present disclosure will be described with reference to drawings.

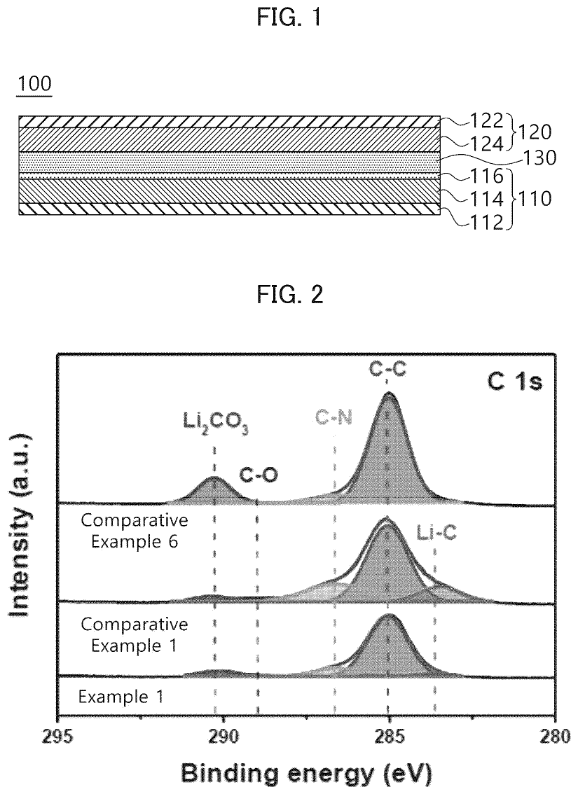

FIG. 1 is a schematic cross-sectional view illustrating a lithium secondary battery according to example embodiments.

Referring to FIG. 1, a lithium secondary battery may include a lithium electrode 110, a cathode 120 and a solid electrolyte layer 130. The solid electrolyte layer 130 may be interposed between the lithium electrode 110 and the cathode 120.

The lithium electrode 110 may include a lithium metal layer 114 and a protective layer 116 covering a surface of the lithium metal layer 114. The lithium electrode 110 may be prepared by the method according to the above-described embodiments.

The lithium metal layer 114 includes a lithium metal. For example, the lithium metal may include a lithium alloy in which lithium atoms are metal-bonded, or lithium atoms and other metal atoms are metal-bonded.

For example, during charge and discharge, electrodeposition and desorption reactions of the lithium metal, rather than oxidation and reduction reactions of active materials, may be substantially a main reversible reaction of the lithium secondary battery. For example, when charging and discharging the lithium secondary battery, the lithium metal may be deposited and desorbed on the lithium metal layer 114 to provide a reversible capacity.

The lithium metal may have a low reaction potential and a high reversible capacity, so that power properties and energy density of the lithium secondary battery may be improved.

The protective layer 116 may be formed to cover at least a portion of one surface (e.g., an upper surface) of the lithium metal layer 114 facing the solid electrolyte layer 130, and may be formed to cover, e.g., an entire upper surface of the lithium metal layer 114.

The protective layer 116 may be formed using the protective layer composition. Accordingly, a ratio between the inorganic materials in the protective layer 116 may be controlled, and a ratio of lithium oxide and lithium nitride may be controlled in an appropriate range.

Ratios or contents between the components included in the protective layer 116 may be measured by an X-ray photoelectron spectroscopy (XPS). For example, the protective layer 116 may be scanned at a binding energy in a range from 200 eV to 600 eV to obtain an XPS spectrum of the protective layer 116. For example, the XPS spectrum may provide peaks corresponding to lithium (Li), nitrogen (N), oxygen (O) and carbon (C).

In example embodiments, an O 1s spectrum of the protective layer 116 may be obtained by scanning the protective layer 116 in a range from 500 eV to 600 eV. A ratio or contents between oxygen-containing components in the protective layer 116 may be measured from the O 1s spectrum.

In the O 1s spectrum of the protective layer 116 measured by the XPS, a ratio of an area of a peak corresponding to Li₂O to an area of a peak corresponding to Li₂CO₃ may be 1.0 or more. The protective layer 116 may be formed using the protective layer composition according to the above-described embodiments, so that the peak area ratio in the above range may be easily obtained.

In the above range, a mechanical strength and an ionic conductivity of the protective layer 116 may be improved, and an interfacial resistance may be reduced. Thus, the life-span and capacity properties of the lithium secondary battery may be enhanced and growth of the lithium dendrites may be suppressed, thereby improving stability.

For example, if the area ratio of the peak corresponding to Li₂O to the peak corresponding to Li₂CO₃ is less than 1.0, the interfacial resistance of the protective layer 116 may be increased due to lithium carbonate. Further, the ratio of lithium oxide is relatively reduced. Accordingly, the mechanical properties and the ion conductivity may be degraded, and the current density may be unevenly distributed on the surface of the lithium metal layer 114 to promote the growth of the lithium dendrites.

Further, lithium carbonate may be converted into lithium carbide during charging and discharging processes. In this case, the protective layer 116 may be damaged, and a contact and a side reaction between the lithium metal layer 114 and the solid electrolyte layer 130 may occur. Accordingly, by-products such as LiCl may be generated to increase the interfacial resistance and degrade stability, and the lithium metal and the electrolyte may be irreversibly consumed.

In an embodiment, in the O 1s spectrum, the Li₂CO₃ peak may be detected at 532.0 eV, and the Li₂O peak may be detected at 527.5 eV. For example, the area of the Li₂CO₃ peak may be calculated as an integral value of a peak detected at a binding energy of 532.0 eV. The area of the Li₂O peak may be calculated as an integral value of a peak observed at a binding energy of 527.5 eV.

In some embodiments, in the O 1s spectrum, the area ratio of the Li₂O peak to the Li₂CO₃ peak may be in a range from 1.0 to 1.9, from 1.2 to 1.9, or from 1.5 to 1.9. In the above range, the protective layer 116 may become more uniform and thinner while providing the increased ion conductivity and mechanical strength.

For example, if the protective layer 116 is formed to have the peak area ratio greater than 1.9, contents of nitromethane and lithium nitrate in the protective layer composition may be excessively increased to accelerate the reaction rate. Accordingly, the protective layer 116 may become relatively non-uniform, and stability may be deteriorated.

In some embodiments, in the O 1s spectrum of the protective layer 116, a ratio of an area of a peak corresponding to the Li₂O to an area of a peak corresponding to a N—O bond may be in a range from 5 to 15. In the above range, the ion conductivity of the protective layer 116 may be improved, and the interfacial resistance and the mechanical strength on the surface of the lithium electrode 110 may be further enhanced.

For example, the area of the N—O bond peak may increase as the content of nitromethane in the protective layer composition increases. When the ratio of the peak area is 5 or more, the mechanical strength of the protective layer 116 may be further increased by Li₂O, and chemical stability may be further improved by preventing unreacted substances from remaining due to an excessive amount of nitromethane.

When the ratio of the peak area is greater than 15, uniformity of the protective layer 116 may be lowered and the thickness may be increased to increase the interfacial resistance.

In an embodiment, the N—O bond peak in the O 1s spectrum may be detected at 532.4 eV.

In an embodiment, in the O 1s spectrum, the ratio of the area of the Li₂O peak to the area of the N—O bond peak may be in a range from 5 to 10, from 6 to 10, or from 7 to 9. When the ratio of the area of the N—O bond peak and the Li₂O peak of the protective layer 116 is in the above range, the interfacial resistance of the protective layer 116 may be further reduced, and the mechanical properties and the ion conductivity may be further enhanced. Additionally, the stability of the protective layer 116 may be increased, so that the side reaction by the electrolyte may be further suppressed. Thus, life-span and resistance properties of the lithium secondary battery may be further improved.

In some embodiments, the thickness of the protective layer 116 may be in a range from 10 nm to 2 μm. As the thickness of the protective layer 116 is greater than or equal to 10 nm, the mechanical strength of the protective layer 116 may be further improved, and the side reaction between the lithium metal layer 114 and the electrolyte may be suppressed by the protective layer 116. Additionally, damages to the protective layer 116 due to a pressure during the fabrication of the lithium secondary battery may be prevented. As the thickness of the protective layer 116 is adjusted to less than or equal to 2 μm, the lithium ion conductivity of the lithium electrode 110 may be further improved and the interfacial resistance may be reduced.

In an embodiment, the thickness of the protective layer 116 may be in a range from 10 nm to 1 μm, from 10 nm to 500 nm, or from 50 nm to 300 nm. Stability of the lithium electrode 110 may be further improved in the above range, and the life-span, power and capacity properties of the lithium secondary battery may be further improved.

In some embodiments, an electrode current collector 112 may be disposed on the other surface (e.g., a bottom surface) of the lithium metal layer 114. For example, the lithium metal layer 114 may be formed on at least one surface of the electrode current collector 112, and may be formed on both surfaces (e.g., a top surface and a bottom surface) of the electrode current collector 112.

The electrode current collector 125 may include gold, stainless steel, nickel, aluminum, iron, titanium, copper, or an alloy thereof. For example, the electrode current collector 125 may include aluminum, stainless steel, copper or a copper alloy surface-treated with carbon, nickel, titanium or silver.

The cathode 120 may include a cathode current collector 122 and a cathode active material layer 124 formed on the cathode current collector 122.

For example, a cathode slurry may be prepared by mixing and stirring a cathode active material with a cathode binder, a conductive material and/or a dispersive agent in a solvent. The cathode slurry may be coated on at least one surface of the cathode current collector 122, and then dried and pressed to prepare the cathode 120.

The cathode current collector 122 may include stainless steel, nickel, aluminum, titanium, or an alloy thereof. The cathode current collector 122 may include aluminum or stainless steel surface-treated with carbon, nickel, titanium or silver.

Examples of the cathode active material include a lithium nickel-based oxide; a lithium cobalt-based oxide such as LiCoO₂; a lithium manganese-based oxide such as LiMnO₃, LiMn₂O₃ and LiMnO₂; a lithium copper oxide such as Li₂CuO₂; a vanadium oxide such as LiV₃O₈, LiFe₃O₄, V₂O₅ and Cu₂VO₇; a lithium iron phosphate oxide such as LiFePO₄; a lithium-sulfur compound such as Li₂S, or the like.

In some embodiments, the cathode active material may include a compound represented by Chemical Formula 1.

LiₐNi_{b}M_{1-b}O₂ [Chemical Formula 1]

In Chemical Formula 1, 0.95≤a≤1.08, b≥0.5, and M may include at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In an embodiment, the cathode active material may include nickel (Ni), and may further include at least one of cobalt (Co) and manganese (Mn). For example, a nickel-cobalt-manganese (NCM)-based lithium oxide may be used as the cathode active material.

For example, nickel (Ni) may serve as a metal related to the capacity of a lithium secondary battery. As a content of nickel increases, the capacity and the power of the lithium secondary battery may be increased. However, when the nickel content is excessively increased, the life-span properties, and a mechanical and electrical stability may be degraded.

In an embodiment, conductivity or resistance properties of the lithium secondary battery may be improved by cobalt (Co), and the mechanical and electrical stability of the lithium secondary battery may be improved by manganese (Mn).

The chemical structure represented by Chemical Formula 1 represents a bonding relationship included in a lattice structure or a crystal structure of the cathode active material, and does not exclude other additional elements. For example, M may serve as a main active element of the cathode active material. Chemical Formula 1 is provided to express the bonding relationship of the main active element, and is to be understood as a formula encompassing introduction and substitution of the additional elements.

In an embodiment, an auxiliary element for enhancing chemical stability of the cathode active material or the crystal structure in addition to the main active element may be further included. The auxiliary element may be incorporated into the crystal structure to form a bond, and this case is to be understood as being included within the range of the chemical structure represented by Chemical Formula 1.

The cathode binder may include polyvinylidene fluoride (PVDF), vinylidene fluoride-co-hexafluoropropylene copolymer (PVDF-co-HFP), polyacrylonitrile, polymethylmethacrylate, acrylonitrile butadiene rubber (NBR), polybutadiene rubber (BR), styrene-butadiene rubber (SBR), etc. In an embodiment, a PVDF-based binder may be used as the cathode binder.

The conductive material may be used to promote a mobility of electrons. For example, the conductive material may include a carbon-based conductive material such as graphite, carbon black, graphene, a carbon nanotube, etc., and/or a metal-based conductive material such as tin, tin oxide, titanium oxide, a perovskite material including LaSrCoO₃ and LaSrMnO₃, etc.

In some embodiments, the cathode active material layer 124 may further include a solid electrolyte. For example, the same compound as an electrolyte included in the solid electrolyte layer 130 to be described later may be used as the solid electrolyte for the cathode. In an embodiment, the solid electrolyte for the cathode may include a sulfide-based electrolyte. For example, the solid electrolyte for the cathode may include an argyrodite-type sulfide-based electrolyte.

The solid electrolyte layer 130 may be disposed between the lithium electrode 110 and the cathode 120. The solid electrolyte layer 130 may prevent a contact and a short circuit between the lithium electrode 110 and the cathode 120, and lithium ions may be transferred between the lithium electrode 110 and the cathode 120 by the solid electrolyte layer 130.

In an embodiment, the solid electrolyte layer 130 may have a sheet shape or a film shape.

In an embodiment, the lithium secondary battery may not include a separator and a liquid electrolyte (an electrolyte solution). For example, a lithium secondary battery may be provided as a solid battery.

The solid electrolyte layer 130 may include a sulfide-based electrolyte, an oxide-based electrolyte, or a polymer electrolyte. The polymer electrolyte may include an ion conductive polymer or a gel polymer electrolyte.

In some embodiments, the sulfide-based electrolyte may be an LPS-based solid electrolyte including Li, P and S, an LGPS-based solid electrolyte including Li, P, Ge, and S, or an LSiPSCl-based solid electrolyte including Li, Si, P, S and Cl.

For example, Li₂S—P₂S₅, Li₁₀SnP₂S₁₂, Li_{9.54}Si_{1.74}P_{1.44}S_{11.7}Cl_{0.3}, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li₁₀GeP₂S_{11.7}O_{0.3}, Li_{9.6}P₃S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li_{9.42}Si_{1.02}P_{2.1}S_{9.96}O_{2.04}, Li₆PS₅Cl, Li₆PS₅Br, Li₆PS₅I, Li₁₀GeP₂S₁₂, Li₃PS₄, Li₇PS₆, Li₇P₃S₁₁, etc., may be used as the as the sulfide electrolyte.

In some embodiments, the sulfide-based electrolyte may have a crystalline structure such as argyrodite, a thio-LISICON type, LGPS, or the like, or an amorphous structure such as glass or glass-ceramic.

In an embodiment, the sulfide-based electrolyte may have an argyrodite crystal structure. For example, the sulfide-based electrolyte may include a compound such as Li₇PS₆, Li_{7-y}PS_{6-y}X_{y} (X is Cl, Br or I), etc.

In an embodiment, the oxide-based electrolyte may include a metal oxide or an ion conductive compound containing oxygen.

Examples of the metal oxide may include Al₂O₃, ZnO₂, Ce₂O₃, TiO₂, ZrO₂, HfO₂, MnO₂, MgO, WO₂, V₂O₅, or the like.

Examples of the ion conductive compound include a garnet-based compound such as an LLZO-based compound (e.g., Li₇La₃Zr₂O₁₂); a perovskite-based compound such as an LLTO-based compound (e.g., Li₃ₓLa_{2/3-x}TiO₃, 0<x<3); a NASICON-based compound such as Li₁₊ₓAlₓGe₂₋ₓ(PO₄)₃ (0<x<2), Li₁₊ₓAlₓTi₂₋ₓ(PO₄)₃ (0<x<2), Li₁₊ₓTi_{2-x-y}AlₓSi_{y}(PO₄)_{3-y} (0≤x≤1, 0<y≤1), an LAGP-based compound, an LATP-based compound, LiAlₓZr₂₋ₓ(PO₄)₃ (0≤x≤1, 0≤y≤1), LiTiₓZr₂₋ₓ(PO₄)₃ (0≤x≤1, 0≤y≤1); an LIPON-based compound; Li₆La₂CaTa₂O₁₂; Li₆La₂ANb₂O₁₂ (A is Ca or Sr); Li₂Nd₃TeSbO₁₂, Li₃BO_{2.5}N_{0.5}; Li₉SiAlO₈, etc.

In some embodiments, the polymer electrolyte may include a polyether-based polymer such as poly(ethylene oxide) or poly(propylene oxide), a polycarbonate-based polymer such as poly(ethylene carbonate), poly(propylene carbonate) or poly(trimethylene carbonate), a polyester-based polymer such as poly(ε-caprolactone) or poly(1,4-butylene adipate), polyacrylonitrile, or the like.

In some embodiments, the solid electrolyte layer 130 may include an argyrodite-type sulfide-based electrolyte. Accordingly, the ionic conductivity and chemical stability of the solid electrolyte layer 130 may be further improved.

The argyrodite-type sulfide-based electrolyte may have a high crystallinity and a low mechanical strength. However, the solid electrolyte layer 130 may be in contact with the protective layer 116 to suppress performance degradation of the solid electrolyte layer 130. Thus, the ionic conductivity of the solid electrolyte layer 130 may be further enhanced, and the life-span properties may be improved.

An electrode cell 100 may be defined by the lithium electrode 110, the solid electrolyte layer 130, and the cathode 120. A plurality of the electrode cells 100 may be sequentially stacked to form an electrode assembly.

The electrode assembly may be accommodated in a case to define a lithium secondary battery. The lithium secondary battery may be manufactured in, e.g., a cylindrical shape using a can, a prismatic shape, a pouch shape, a coin shape, or the like.

In some embodiments, a separator may be further interposed between the lithium electrode 110 and the cathode 120. The separator may include a porous polymer film formed of a polyolefin-based polymer such as an ethylene homopolymer, a propylene homopolymer, an ethylene/butene copolymer, an ethylene/hexene copolymer, an ethylene/methacrylate copolymer, etc. The separator may also include a nonwoven fabric formed of a high-melting-point glass fiber, a polyethylene terephthalate fiber, etc.

Electrode tabs (e.g., a cathode tab and an anode tab) may protrude from each electrode current collector 112 and the cathode current collector 122 included in each electrode cell 100 and may extend to one side of the case. The electrode tabs may be fused together with the one side of the case to form electrode leads (a cathode lead and an anode lead) that may be extended or exposed to an outside of the case.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Examples and Comparative Examples

### (1) Fabrication of Lithium Electrode

Lithium nitrate (LiNO₃) and nitromethane were quantitatively added to dimethoxyethane (1,2-dimethoxyethane) and mixed to prepare a protective layer composition. Contents of lithium nitrate, nitromethane and dimethoxyethane were adjusted as shown in Table 1 below. In Table 1 below, the contents (wt %) of nitromethane and dimethoxyethane were calculated based on a total weight of an organic solvent. Lithium nitrate was added to the organic solvent at a concentration of 0.01 M (0.07 weight %) based on a total weight of the protective layer composition.

A lithium metal layer was placed in a beaker containing the protective layer composition, and left for 1 hour at a temperature of 60° C. The lithium metal layer was taken out from the beaker and washed with dimethoxyethane. The lithium metal layer was naturally dried in a glove box to obtain a lithium electrode.

### (2) Fabrication of Lithium Secondary Battery

A cathode was manufactured by mixing LiNi_{0.8}Co_{0.1}Mn_{0.1}O₂ as a cathode active material, carbon black as a conductive material, and argyrodite-based solid electrolyte (Li₆PS₅Cl) were mixed in a weight ratio of 67:3:30.

A pressurized cell was manufactured using the cathode and the lithium electrode.

Specifically, the lithium electrode and the cathode were each notched into a circular shape. 100 mg of the solid electrolyte (Li₆PS₅Cl) was placed in a SUS circular mold having the same diameter as the circular shape and uniaxially pressed by 2 tons to obtain a solid electrolyte pellet. The lithium electrode and the cathode were placed on each of both sides of the pellet, and pressed by 2 tons to obtain an electrode cell. The electrode cell was assembled into a pressurized cell having a diameter of 16 mm.

In Comparative Example 6, a pure lithium metal without the protective layer was used as the lithium electrode.

TABLE 1

| | lithium nitrate | nitromethane | dimethoxyethane |
|---|---|---|---|
| | (concentration) | (wt %) | (wt %) |
| Example 1 | 0.01M | 50 | 50 |
| Comparative | — | 50 | 50 |
| Example 1 | | | |
| Comparative | 0.01M | — | 100 |
| Example 2 | | | |
| Comparative | — | 100 | — |
| Example 3 | | | |
| Comparative | 0.01M | 75 | 25 |
| Example 4 | | | |
| Comparative | 0.01M | 25 | 75 |
| Example 5 | | | |

### (3) XPS Measurement of the Protective Layer

An XPS analysis was performed on the protective layer formed according to Example and Comparative Examples using ESCALAB 250Xi from Thermo Scientific.

The XPS analysis was performed under the following conditions.
i) X-ray: Al k alpha, 1486.68 eV, 900 μm Beam size
ii) Analyzer: CAE Mode
iii) Number of scans: 2 (survey scan), 20 (Narrow Scan)
iv) Pass energy: 150 eV (survey Scan), 20 eV (Narrow Scan)
v) Ion gun: Ar ion
vi) Ion energy: 4000 eV

A scan range of the binding energy may be adjusted to obtain a C 1s spectrum, an N 1s spectrum and an O 1s spectrum of the protective layer.

FIG. 2 is a graph showing C 1s spectra of Example 1, Comparative Example 3, and Comparative Example 6.

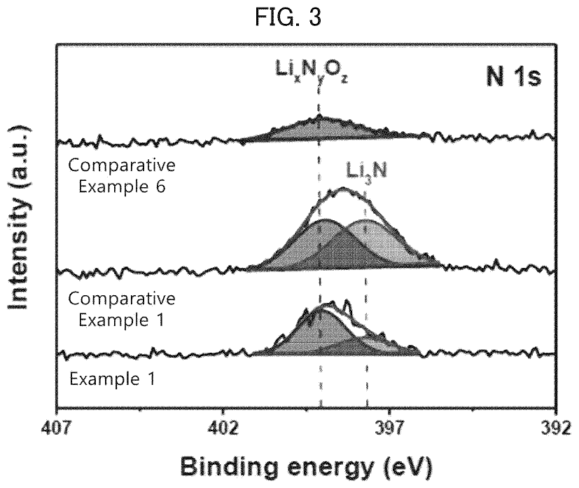

FIG. 3 is a graph showing N 1s spectra of Example 1, Comparative Example 3, and Comparative Example 6.

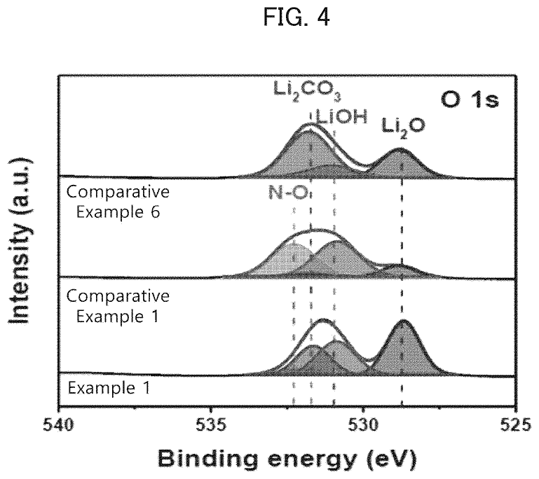

FIG. 4 is a graph showing O 1s spectra of Example 1, Comparative Example 3, and Comparative Example 6.

Referring to FIGS. 2 to 4, in the case of Comparative Example 1, a Li—C peak area was relatively increased compared to that of Example 1. In the case of Comparative Example 6, a Li₂CO₃ peak area was relatively increased compared to that of Example 1.

In the case of Comparative Example 1, a ratio of Li₂O was relatively decreased compared to that of Example 1, and a ratio of an N—O peak was explicitly increased. In the case of Comparative Example 6, the Li₂CO₃ peak area was increased compared to that of Example 1.

The O 1s spectrum of the protective layer formed according to Example and Comparative Examples was obtained by the above-described method. In the O 1s spectrum, areas of the Li₂O peak (527.5 eV), the Li₂CO₃ peak (532.0 eV), and the N—O bond peak (532.4 eV) were measured, and ratios between the peak areas were calculated.

In the O 1s spectra of Comparative Example 2 and Comparative Example 6, the N—O peak was not observed. In Comparative Examples 2 and 6 of Table 2 below, the Li₂O/N—O peak area ratio is expressed as

The measurement results are shown in Table 2 below.

TABLE 2

| | Li₂O/Li₂CO₃ | Li₂O/N—O |
|---|---|---|
| area ratio | (@ O ls) | (@ O ls) |
| Example 1 | 1.78 | 7.49 |
| Comparative | 2.88 | 0.18 |
| Example 1 | | |
| Comparative | 1.92 | — |
| Example 2 | | |
| Comparative | 2.92 | 0.23 |
| Example 3 | | |
| Comparative | 2.57 | 15.51 |
| Example 4 | | |
| Comparative | 1.99 | 4.61 |
| Example 5 | | |
| Comparative | 0.48 | — |
| Example 6 | | |

Referring to Table 2, in Example, the content of nitromethane in the protective layer composition was 25 wt % or more based on the weight of the organic solvent, and the Li₂O/Li₂CO₃ peak area ratio was in a range from 1.0 to 1.9.

In Comparative Examples 1 to 5, the Li₂O/Li₂CO₃ peak area ratio exceeded 1.90. In Comparative Example 6, the Li₂O/Li₂CO₃ peak area ratio was less than 1.0. In Comparative Examples 1, 3 and 5, the area of the N—O peak was explicitly increased. In Comparative Example 4, the area of the N—O peak was explicitly decreased.

### Experimental Example

### (1) Evaluation on Surface Property of Lithium Electrode

A surface of the lithium electrode was obtained using a scanning electron microscope (SEM) to observe a surface of the lithium electrode. The Helios Nanolab 650 from Thermo Fisher was used as the SEM.

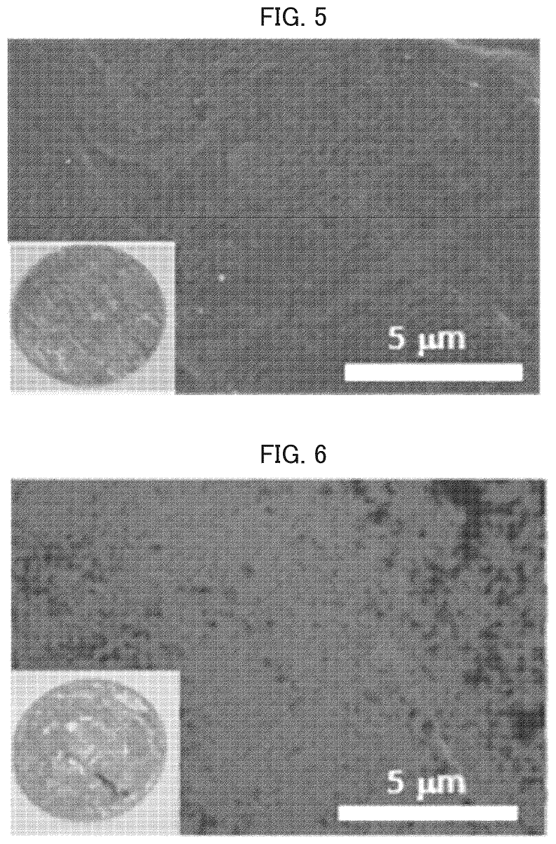

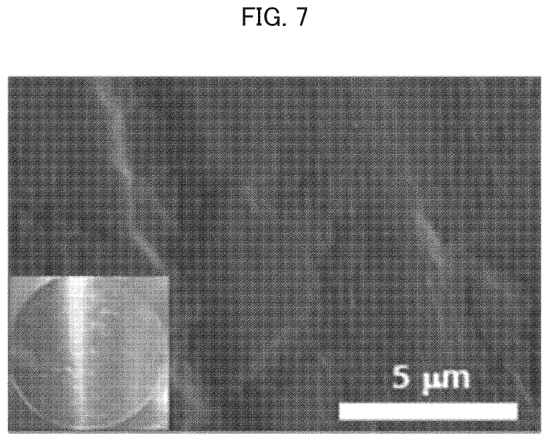

FIG. 5 is a surface scanning electron microscope (SEM) image of a lithium electrode according to Comparative Example 6. FIG. 6 is a surface SEM image of a lithium electrode according to Comparative Example 3. FIG. 7 is a surface SEM image of a lithium electrode according to Example 1.

Referring to FIG. 7, a uniform protective layer was formed in the lithium electrode according to Example 1. Referring to FIG. 6, in Comparative Example 3, the surface of the lithium electrode was uneven, and the protective layer composition did not contain lithium nitrate and impurities were present on the surface of the lithium metal layer. Referring to FIG. 5, in the lithium electrode of Comparative Example 6, the pure lithium metal layer was used and the surface of the lithium electrode was relatively uniform compared to that of Comparative Example 3.

### (2) Evaluation on Life-Span Property

For the lithium secondary batteries of Example and Comparative Examples, an initial charge and discharge (formation process) was performed at a current density of 0.1 C. Thereafter, 200 cycles were performed with a charge (CC 4.25 V cut-off) and a discharge (CC 2.5 V cut-off) as a single cycle. Charge and discharge capacities at each cycle were measured to obtain a charge/discharge curve.

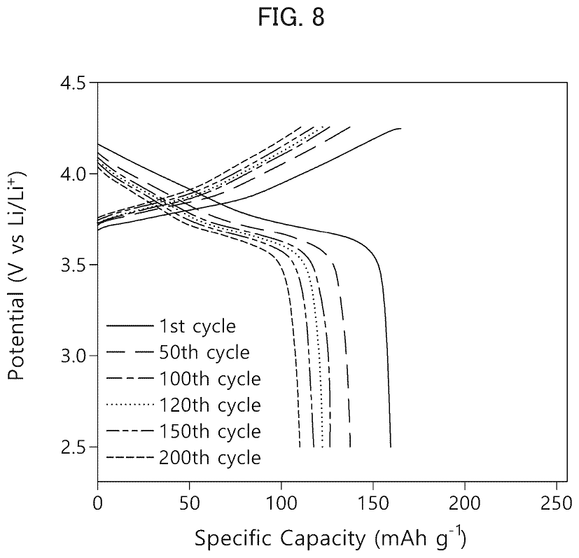

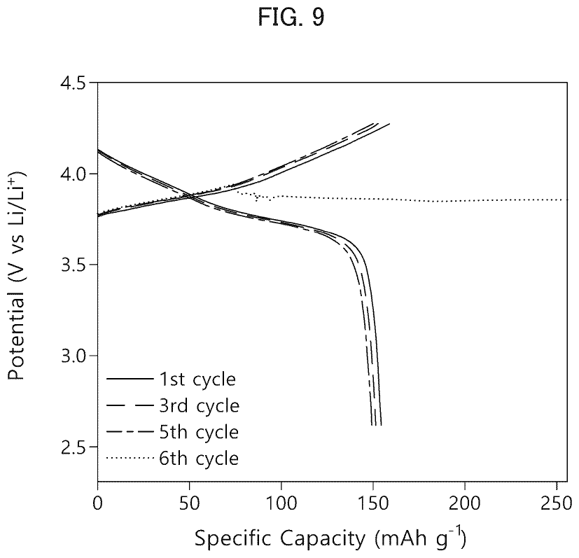

FIG. 8 is a charge/discharge curve graph of a lithium secondary battery according to Example 1. FIG. 9 is a charge/discharge curve graph of a lithium secondary battery according to Comparative Example 6.

Referring to FIGS. 8 and 9, an overcharge due to a short circuit occurred during the charge of the 6th cycle in Comparative Example 6. In Example 1, stable charge and discharge properties were shown without a short circuit until 200 cycle were completed.

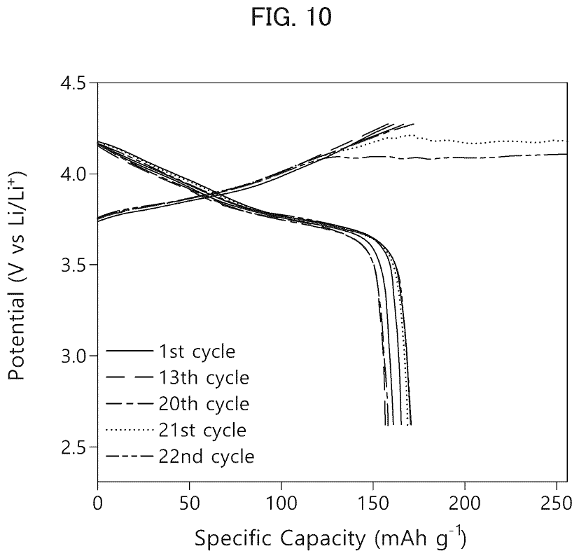

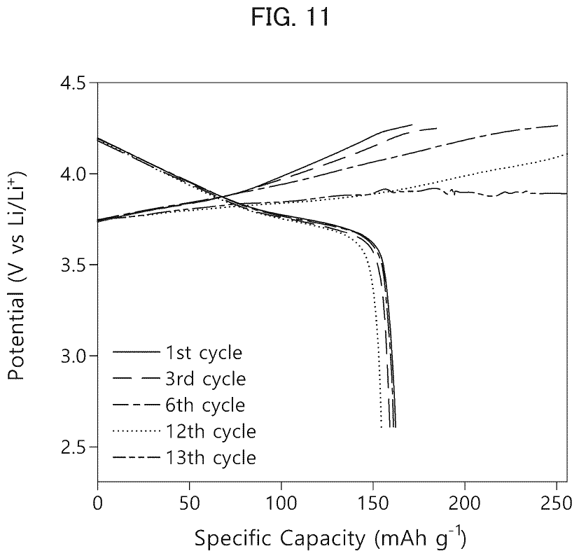

FIG. 10 is a charge/discharge curve graph of a lithium secondary battery according to Comparative Example 3. FIG. 11 is a charge/discharge curve graph of a lithium secondary battery according to Comparative Example 2.

Referring to FIGS. 10 and 11, in Comparative Examples 2 and 3, short circuits occurred at the 13th cycle and the 22nd cycle, respectively.

The number of cycles during the 200 charge/discharge cycles until the short circuit and the overcharge did not occur was evaluated

The measurement results are shown in Table 3 below.

### (3) Resistance Evaluation

Resistances of the lithium secondary batteries according to Examples and Comparative Examples were measured initially, after 2 days of storage, and after 4 days of storage. The resistance of each lithium secondary battery was measured at room temperature (25° C.) at 50% SOC by 10 seconds of discharge at 1 C.

The measurement results are shown in Table 3 below.

TABLE 3

| | | resistance (Ω) | | |
|---|---|---|---|---|
| | the number | | two days | four days |
| | of cycles | initial phase | of storage | of storage |
| Example 1 | 200 | 7.5 | 11.5 | 14.3 |
| Comparative | 5 | 9.0 | 20.1 | 27.5 |
| Example 1 | | | | |
| Comparative | 24 | 7.9 | 12.0 | 14.9 |
| Example 2 | | | | |
| Comparative | 8 | 9.3 | 22.2 | 29.9 |
| Example 3 | | | | |
| Comparative | 102 | 8.0 | 12.5 | 15.5 |
| Example 4 | | | | |
| Comparative | 86 | 7.6 | 12.8 | 16.4 |
| Example 5 | | | | |
| Comparative | 5 | 10.2 | 27.3 | 33.9 |
| Example 6 | | | | |

Referring to Table 3, the lithium secondary battery of Example 1 had improved cycle properties, and the initial resistance and a resistance increase ratio of the lithium secondary battery were low.

However, the lithium secondary batteries of Comparative examples had short circuits or overcharges before 200 cycles, and the initial resistance and the resistance increase ratio were relatively high compared to those from Example 1.

### (4) Evaluation on Interface Property

The lithium secondary batteries of Example 1 and Comparative Example 6 were left for 1000 hours.

Each lithium secondary battery was disassembled, and an image of an interface between the lithium electrode and the solid electrolyte was obtained in a cross-sectional direction using an SEM and an EDX (Energy dispersive X-ray spectroscopy). The EDX was measured under the conditions of an acceleration voltage of 5 kV, a pulse throughput of 60 eV/count, and a working distance of 8.5 mm by an equipment linked to the SEM.

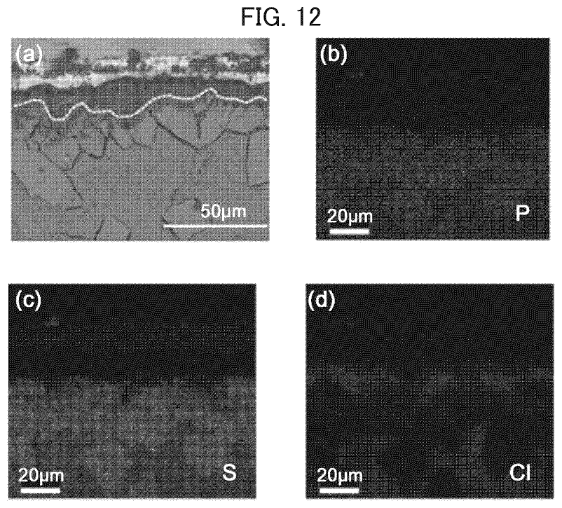

FIG. 12 is a scanning electron microscope-energy dispersive X-ray spectroscopy (SEM-EDX) image of an interface between a lithium electrode and a solid electrolyte of Example 1.

In FIG. 12, (a) is a SEM image of the interface, and (b), (c) and (d) are EDX images showing distributions of P, S and Cl elements at the interface, respectively.

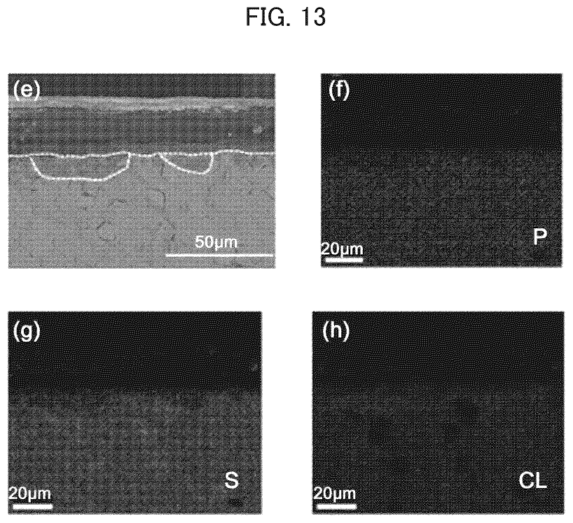

FIG. 13 is a SEM-EDX image of an interface between a lithium electrode and a solid electrolyte of Comparative Example 6.

In FIG. 13, (e) is a SEM image of the interface, and (f), (g) and (h) are EDX images showing distributions of P, S, and Cl elements at the interface, respectively.

Referring to FIGS. 12 and 13, in Comparative Example 6, LiCl as a by-product of the solid electrolyte was detected at the interface of the lithium electrode and the solid electrolyte. Additionally, the lithium electrode became thinner, and was thinned and a shape of the lithium electrode was deformed.

In Example 1, LiCl was hardly detected at the interface, a thickness of the lithium electrode was maintained, and no shape deformation was observed.

The above descriptions are merely an example of applying the spirits of the present disclosure, and other elements may be further included without departing from the scope of the present disclosure.

What is claimed is:

1. A composition for a lithium metal protective layer, comprising:
an organic solvent comprising nitromethane and dimethoxyethane; and
lithium nitrate (LiNO₃),
wherein a content of nitromethane is in a range from 30 wt % to 70 wt % based on a total weight of the organic solvent.

2. The composition for a lithium metal protective layer according to claim 1, wherein the content of nitromethane is in a range from 40 wt % to 70 wt % based on the total weight of the organic solvent.

3. The composition for a lithium metal protective layer according to claim 1, wherein a content of dimethoxyethane is in a range from 30 wt % to 70 wt % based on the total weight of the organic solvent.

4. The composition for a lithium metal protective layer according to claim 1, wherein a weight ratio of nitromethane to dimethoxyethane in the organic solvent is in a range from 0.5 to 2.0.

5. The composition for a lithium metal protective layer according to claim 1, wherein a content of lithium nitrate is in a range from 0.01 wt % to 3.0 wt % based on a total weight of the composition.

6. The composition for a lithium metal protective layer according to claim 1, wherein the organic solvent further comprises at least one auxiliary solvent selected from the group consisting of methylpyrrolidone, dimethylformamide, dimethylacetamide, acetonitrile, dinitrobenzene, dimethyl sulfoxide, dimethyl ether, dimethyl carbonate and tetrahydrofuran.

7. The composition for a lithium metal protective layer according to claim 1, further comprising at least one lithium salt selected from the group consisting of lithium bistrifluoromethanesulfonylimide (LiTFSI), lithium bisfluorosulfonylimide (LiFSI), lithium difluorooxalatoborate (LiDFOB), lithium bisoxalatoborate (LiBOB), lithium hexafluorophosphate (LiPF₆), lithium tetrafluoroborate (LiBF₄) and lithium perchlorate (LiClO₄).

8. A method of fabricating a lithium electrode comprising forming a protective layer on a surface of a lithium metal layer by immersing the lithium metal layer in the composition for a lithium metal protective layer according to claim 1.

9. The method of claim 8, wherein a lithium metal and the composition for a lithium metal protective layer react on a surface of the lithium metal layer to form lithium nitride and lithium oxide.

10. The method of claim 9, wherein lithium nitride and lithium oxide are formed by a reductive reaction of nitromethane and lithium nitrate.

11. The method of claim 8, further comprising washing the lithium metal layer on which the protective layer is formed with dimethoxyethane.

12. A lithium electrode, comprising:
a lithium metal layer; and
a protective layer disposed on the lithium metal layer, the protective layer comprising lithium nitride and lithium oxide,
wherein, in an O 1s spectrum of the protective layer measured by an X-ray photoelectron spectroscopy (XPS), a ratio of an area of a peak corresponding to Li₂O to an area of a peak corresponding to Li₂CO₃ is in a range from 1.0 to 1.9.

13. The lithium electrode according to claim 12, wherein, in the O 1s spectrum of the protective layer, the ratio of the area of the peak corresponding to Li₂O to the area of the peak corresponding to Li₂CO₃ is in a range from 1.2 to 1.9.

14. The lithium electrode according to claim 12, wherein, in the O 1s spectrum of the protective layer, a ratio of the area of the peak corresponding to Li₂O to an area of a peak corresponding to a N—O bond is in a range from 5 to 15.

15. The lithium electrode according to claim 12, wherein a thickness of the protective layer is in a range from 10 nm to 2 μm.

16. A lithium secondary battery, comprising:
the lithium electrode according to claim 12;
a cathode facing the lithium electrode; and
a solid electrolyte disposed between the lithium electrode and the cathode.
